(19) United States
(12) Patent Application Publication
(10) Pub. No.: US 2026/0355772 A1
(43) Pub. Date: Nov. 12, 2026

(54) COMPACT VERTICALLY DEPLOYABLE DEVICES FOR FLUID APPLICATION

(71) Applicant: BLUE ORIGIN MANUFACTURING, LLC, Huntsville, AL (US)

(72) Inventors: Jordan Tyler Choate, Olympia, WA (US); Gary Takashi Nishimura, Renton, WA (US); William Alan Toffler, West Melbourne, FL (US)

(21) Appl. No.: 19/205,565

(22) Filed: May 12, 2025

(51) Int. Cl. B05B 13/06; B08B 9/093

(52) U.S. Cl. CPC B05B 13/0636; B08B 9/0936

(57) ABSTRACT

A storage tank interior spraying assembly may include an externally supported base, a rotatable spraying device, and a fluid delivery system. The externally supported base may include a plurality of deployable components to be positioned at least partially below an opening of the storage tank. The deployable components may form and vertically extend a mast during deployment. The rotatable spraying device may be raised into the storage tank interior through the opening with the mast during deployment. The fluid delivery system may provide fluid to the spraying device to be sprayed within the storage tank interior.

### TECHNICAL FIELD

Developments herein relate generally to ground-based extensible fluid delivery systems and methods of use thereof, and particularly to spraying interior surfaces of upright tanks.

### BACKGROUND

Applying fluids to large-scale horizontally positioned surfaces can be resource-and time-consuming and space inefficient. Systems with fixed vertical surfaces, such as launch site towers or tall building exteriors, can require portable fluid application devices to avoid permanent installations. However, typical portable fluid application devices can have several issues, such as long setup times, limited power, fewer features, reduced vertical reach, or other limitations.

Rocket propelled launch vehicles can require detailed cleaning able to satisfy cleanliness requirements, such as for parts to be approved for use or reuse. Movable systems with vertical surfaces, such as rocket propellant tanks, can require a compact application device to avoid repositioning the system from a vertical orientation to a horizontal orientation or supporting the application device inside of the system to access interior surfaces. A typical process to clean the tanks can require positioning the tanks in a horizontal orientation. However, positioning the tanks in a horizontal orientation can have several issues, such as potential damage caused by repositioning, gaining access to the interior of the tank, the cleaning solution/fluid accumulating on a bottom along a cylinder or sphere of the tank and becoming difficult to remove, dangers associated with having people inside of the tank, difficulty collecting drained fluid sample, or other limitations.

### SUMMARY

In one example, a storage tank interior spraying assembly includes a base, a rotatable spraying device, and a fluid delivery system. The base includes a plurality of deployable components to be positioned at least partially below an opening of the storage tank. The deployable components form and vertically extend a self-supporting mast during deployment. The rotatable spraying device can be raised into the storage tank interior through the opening with the self-supporting mast during deployment. The fluid delivery system provides fluid to the spraying device to be sprayed within the storage tank interior.

In another example, a fluid application device includes one or more nozzles, at least one component to provide a flow of fluid, and an automatically erecting tower. The one or more nozzles can apply a flow of fluid in a plurality of directions. The automatically erecting tower receives the one or more nozzles. The one or more nozzles are positioned along a height as the tower is erected. The automatically erecting tower can be retracted below at least a portion of a surface spanning a vertical distance.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from spirit or scope of the subject matter presented here. In some drawings, various structures according to embodiments of the present disclosure are schematically shown. However, the drawings are not necessarily drawn to scale, and some features may be enlarged while some features may be omitted for the sake of clarity. It will be readily understood that the aspects of the present disclosure, as generally described herein, and illustrated in the figures, can be arranged, substituted, combined, and designed in a wide variety of different configurations, all of which are explicitly contemplated and make part of this disclosure. As noted above, the drawings as depicted are not necessarily drawn to scale. The relative dimensions and proportions as shown are not intended to limit the present disclosure, unless indicated otherwise. Various embodiments in accordance with the present disclosure will be described with reference to the drawings, in which:

FIG. 1 illustrates an example fluid spraying assembly, in accordance with at least one embodiment;

FIGS. 2A, 2B, 2C, and 2D illustrate cut-out views of an example fluid spraying assembly, in accordance with at least one embodiment;

FIG. 3 illustrates another example fluid spraying assembly, in accordance with at least one embodiment;

FIG. 4A illustrates an example spraying device for a fluid spraying assembly, in accordance with at least one embodiment; and

FIG. 4B illustrates an alternative example spraying device for a fluid spraying assembly, in accordance with at least one embodiment;

FIG. 5 illustrates an example control system for a fluid spraying assembly, in accordance with at least one embodiment; and

FIG. 6 illustrates an example process that can be performed to apply fluid to a surface, in accordance with at least one embodiment.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. It should be further appreciated that terms such as approximately or substantially may indicate +/−10 percent.

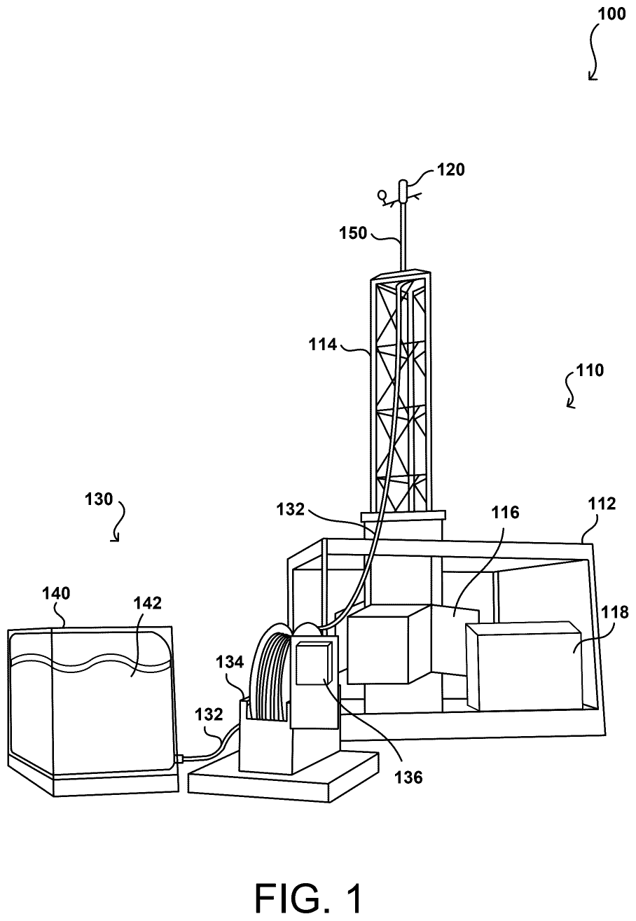

FIG. 1 illustrates an example fluid spraying assembly 100, in accordance with at least one embodiment. The fluid spraying assembly 100 may include a base 110, a spraying device 120, and a fluid delivery system 130 to provide maximal stability, strength, and portability for applying fluids, which may include liquid, gas, steam, or other suitable materials. The fluid spraying assembly 100 may be used for spraying the interior of storage tanks, such as propellant storage tanks, in a vertical or upright orientation to facilitate a high rate of production and may be used as a part of a contamination control plan. One or more of these, or components thereof, may be permanently attached, removable, or integrated with others of these. The base 110 may be externally supported and may include one or more of a support 112, a deployable mast 114, a mast storage system 116, and a base control unit 118. One or more components of the fluid spraying assembly 100, such as the base 110, may be secured in place or may be portable, such as including wheels or being attached to a vehicle. In an example, one or more components of the fluid spraying assembly 100, such as the base 110, may contain fork pockets for transportation using a forklift or other suitable tool. In another embodiment, one or more components of the fluid spraying assembly 100, such as the base 110, may contain one or more lift points that allow the components to be lifted, such as with a crane or other suitable tool. The support 112 may be able to provide structural stability to one or more components, such as a frame to support the deployable mast 114 in a deployed state.

The deployable mast 114 may be a self-supporting mast or structure able to transition from a stored state to a deployed state. The deployable mast 114 may be self-supporting by being able to raise, lower, and maintain the position of the spraying device 120 during operation while anchored only through the base 110 or support 112, such as without requiring additional cables, section locks, guy wires, locking telescoping sections, or other supporting features. In some embodiments, the deployable mast 114 may also be supported using one or more cables, section locks, guy wires, locking telescoping sections, or other supporting features. The deployable mast 114 may be deployed from a plurality of deployable components. The deployable components may include rigid interlocking columns able to maximize efficiency and stability of the deployable mast 114. The mast storage system 116 may store the deployable mast 114 or the deployable components in a stored or undeployed state. The mast storage system 116 may be used to combine the deployable components to form the self-supporting deployable mast 114. The deployable components may be vertically extendable to adjust a length of the deployable mast 114 during deployment. For example, the mast storage system 116 and the deployable mast 114 may be, for example a STS-12 Tower manufactured by Tower Solutions, or Deployable Interlocking Actuated Band for Linear Operations (DIABLO) manufactured by Honeybee Robotics, or other suitable masts. The mast storage system 116 may be able to raise a fully equipped deployable mast 114 from ground level to about 120 feet in less than about 10 minutes or less than about 5 minutes. A portion of the deployable components may be used to partially deploy the deployable mast 114. In an example, the deployable mast 114 may be capable of partially extending to a height from the ground up to at least about 510 inches, 602 inches, or another height suitable to spray a rocket propellant tank, such as a liquid oxygen (LOX) tank or a liquid hydrogen (LH2) tank. The base control unit 118 may include components or systems to control one or more features of the base 110 or the fluid spraying assembly 100, such as a power, hydraulic, pneumatic, or electric system, as well as pumps, supplies, interfaces, or other suitable parts. One or more user interfaces may be associated with the fluid spraying assembly 100 or the base control unit 118 to allow a user to provide instructions or receive information. For example, the user interface may include a wired or wireless device able to operate one or more components of the fluid spraying assembly 100, such as the deployable mast 114, the hose reel 134, the spraying device 120, pumps, sensors, or other components. In another example, components or operations of the fluid spraying assembly 100 may be controlled automatically, such as using automated programs that require minimal user interaction.

The spraying device 120 may include spray deployment equipment to spray the fluid to a surface and may be secured to the deployable mast 114, such as using a mount. The spraying device 120 may include one or more nozzles, spray heads, fluid valves, camera equipment, rotation systems, directional devices, connectors, fittings, or other fluid and electronics equipment that must reside near the spray deployment. The spraying device 120 may be rotatable or directionally controlled, such as to apply the fluid to an entire surface or a plurality of surfaces. The spraying device 120 may be positioned at or near the top of the deployable mast 114. The fluid delivery system 130 may be able to provide fluid to the spraying device 120 and may include one or more of at least one hose 132 or other fluid transfer device, a hose reel 134 or other hose management device, and a fluid delivery control system. The fluid delivery system 130 may be a part of, or connected to, the base 110. The hose reel 134 may be able to provide at least the length of hose required to extend with the deployment of the deployable mast 114. The fluid delivery system 130 may also include a fluid delivery control unit 136, which includes components or systems able to control one or more features of the fluid delivery system 130, such as the hose reel or a pump. The fluid delivery control unit 136 may be part of or interface with the base control unit 118. The spraying device 120 may be at least partially controlled by one or more of the base control unit 118 and the fluid delivery control unit 136.

The fluid delivery system 130 may be connected or connectable with a fluid source 140, which contains one or more fluids 142 or other materials to be applied to a surface. The fluid delivery system 130 may include the fluid source 140 or may be connectable to an external fluid source, such as a permanent fluid supply line. The fluid spraying assembly 100 may also include a secondary extension member 150 able to position the spraying device 120 or one or more nozzles relative to the deployable mast 114, such as closer and farther or tilting at an angle. The secondary extension member 150 may be a part of the deployable mast 114 or the spraying device 120. The top of the deployable mast 114 may be able to support the spraying device 120, which may include at least nozzles, spray heads, fluid valves, camera equipment, and other fluid and electronics equipment that must reside near the spray deployment. In an example, equipment and materials on top of the deployable mast 114 may weigh about 150 pounds, including hoses, cables, and other equipment hanging from the deployable mast 114. At least some of the components extending up to the equipment and materials on top of the deployable mast 114, including hoses and cables, may be retained outside of an exterior boundary of the deployable mast 114.

In one example, the fluid spraying assembly 100 may be used to spray the interior of a storage tank, such as a propellant tank, or a tank used in the aerospace or spacecraft industry, in a vertical orientation. The deployable components of the base 110 may be positioned at least partially below an opening of the storage tank. The deployable mast 114 may be formed from the deployable components and vertically extended into the storage tank interior through the opening. The spraying device 120 may be raised into the storage tank interior through the opening with the deployable mast 114. The fluid delivery system 130 may provide the fluid 142 to the spraying device 120 to be sprayed within the storage tank interior. The fluid spraying assembly 100 may be used to perform different spraying operations or tasks, such as cleaning, coating, painting, spraying exterior surfaces of objects, spraying buildings, heating, cooling, drying, fire suppression, or other processes. For example, the fluid spraying assembly 100 may also be able to dry a surface, such as using existing or additional components to apply air or heat to a surface or object.

Using the fluid spraying assembly 100 to spray fluid on internal surfaces of structures positioned in a vertical orientation, such as cylindrical structures, may allow for completing processes faster and reducing the drying time than doing so in a horizontal orientation, and furthermore, may remove the need for repositioning of the structure and reduce at least some use of resources, including manpower, during the processes. Using the fluid spraying assembly on structures positioned in a vertical orientation further alleviates the need for ensuring there is a sufficient square footage area that could accommodate the structure in a horizontal orientation. The fluid spraying assembly 100 may be a movable, large-scale cleaning device for aerospace or propellant tank applications, with at least two vertical extension sections and rotating variable angle nozzles. For example, by applying fluid to a surface in a vertical orientation rather than a horizontal orientation, sprayed fluid may drain faster due to gravity and, therefore, allow for faster drying and reducing the need for vacuums or heat application. This may also allow for more effective cleaning processes, since the processed fluid and removed material will not rest at the bottom of the surface or object, and instead can drain out vertically, such as through a polar opening. Additionally, automating one or more features or operations of the fluid spraying assembly 100 may increase repeatability, and therefore remove potential variations introduced by humans.

The fluid spraying assembly 100 or similar system may be compact enough, with the deployable mast 114 stowed, to deploy fluid through an opening of about 40 inches from a height of about 10 feet up to about 55 feet. The fluid spraying assembly 100 may be able to deploy fluid through openings of other sizes and between heights of other distances. For example, the fluid spraying assembly 100 may have a ratio of the maximum deployed distance of the deployable mast 114 to the maximum width of the base 110 or mast storage system 116 of at least about 7:1, about 4:1, about 10:1, or other suitable ratios. In another example, the fluid spraying assembly 100 may have a ratio of maximum height to maximum width of the deployable mast 114 of at least about 20:1, about 6:1, about 50:1, or other suitable ratios. In yet another example, the extended height to retracted height ratio of the fluid spraying assembly 100 may be at least about 10:1, about 7.5:1, about 15:1, or other suitable ratios, wherein the fluid spraying assembly 100 and/or the extendable mast 114 is self-supporting. The footprint of the fluid spraying assembly 100 may be about 5,000 square inches, about 7,500 square inches, about 10,000 square inches, or other suitable size. Therefore, the fluid spraying assembly 100 addresses the limitations of previous solutions by providing a controlled, stable extension to a high elevation, with a compact retracted height in order to apply fluids to surfaces.

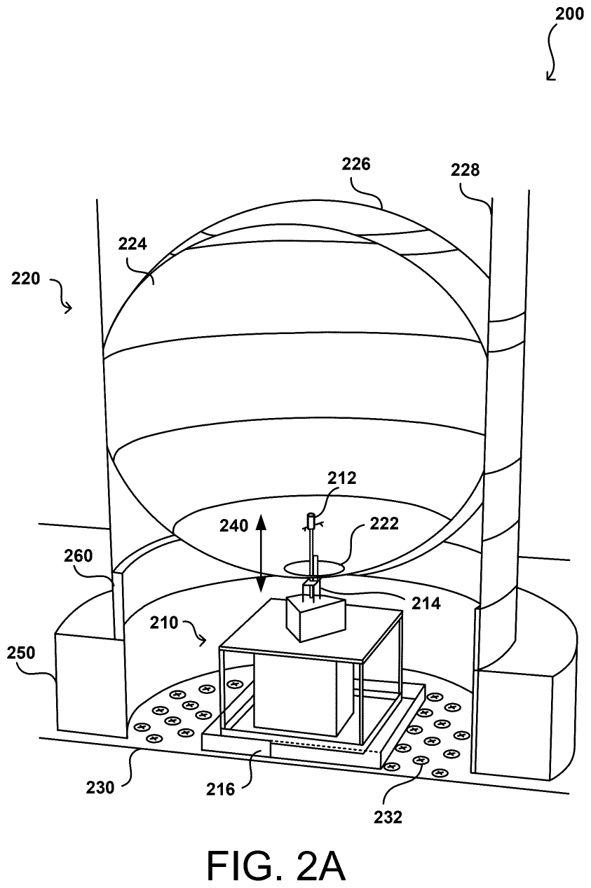

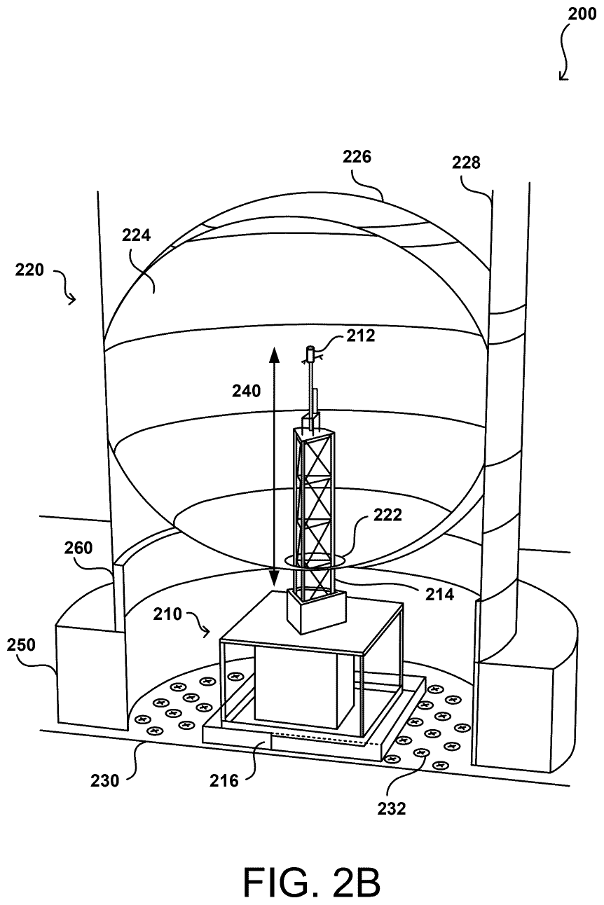

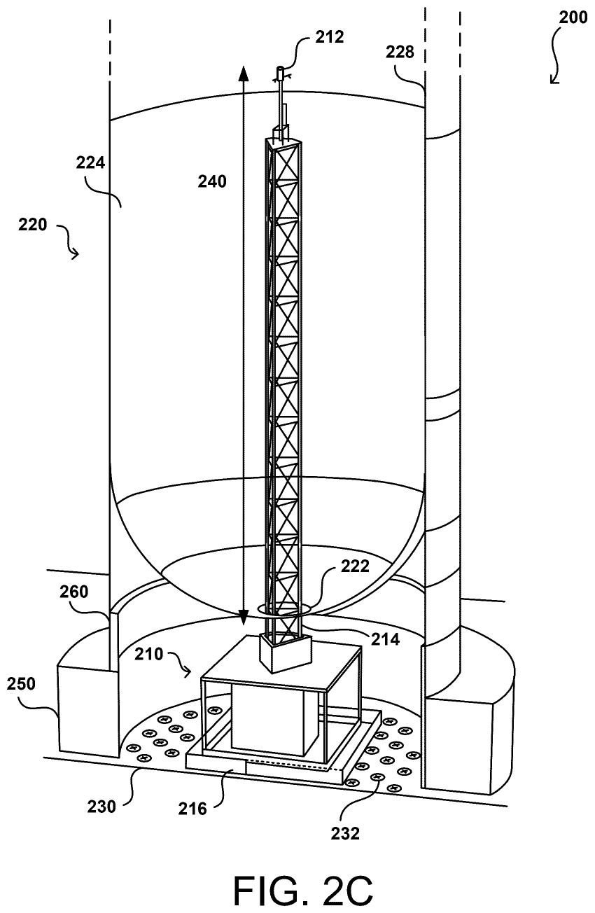

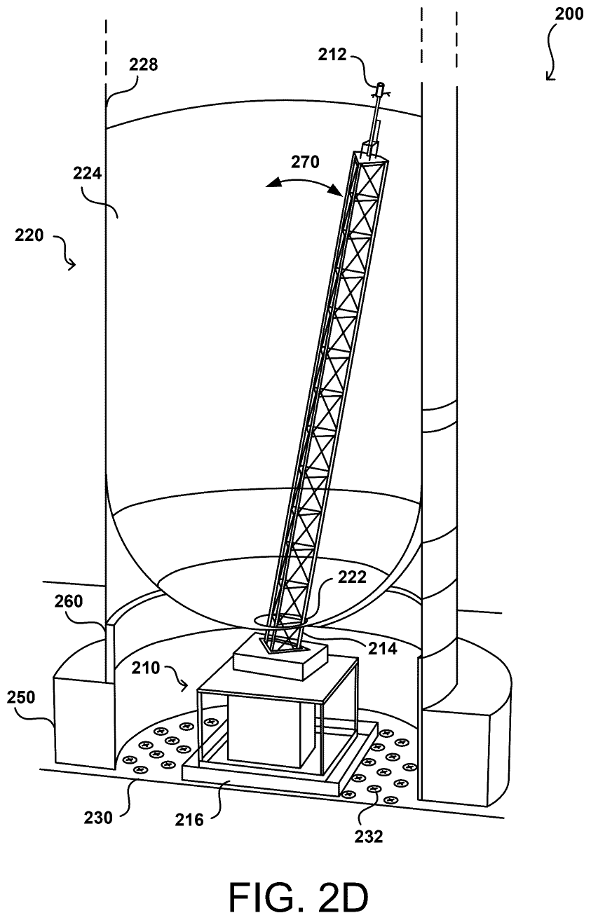

FIG. 2A illustrates a cut-out view of an example fluid spraying assembly 200 in an undeployed state, in accordance with at least one embodiment. The fluid spraying assembly 200 may include a fluid application device 210 able to be positioned at least partially under an object 220, such as a storage tank, or an opening 222 of a surface 224 to be sprayed. The opening may be located at a bottom or a polar end of the object 220 or of the surface 224. For example, the object 220 may include a LOX tank 226 and/or a LH2 tank 228, such a tank that includes an opening of the LOX tank 226 portion at one end an opening of the LH2 tank 228 portion. The fluid application device 210 may include spray deployment equipment 212 and an erecting tower 214 or telescoping tower. The spray deployment equipment 212 may be used to spray a fluid from the tower 214 onto the surface 224. The spray deployment equipment 212 may include one or more nozzles, spray heads, fluid valves, camera equipment, rotation systems, directional devices, connectors, fittings, or other fluid and electronics equipment that must reside near the spray deployment.

The fluid spraying assembly 200 may also include components to provide the flow of fluid to the spray deployment equipment 212. The spray deployment equipment 212 may be able to apply a flow of fluid in a plurality of directions to the surface 224. The tower 214 may be able to receive the spray deployment equipment 212 at or near a top portion of the tower 214. The tower 214 may be erected, such as automatically assembled, to pass through the opening 222 into the object 220. The spray deployment equipment 212 may be positioned along a height 240 as the tower 214 is erected. Components of the fluid spraying assembly 200, such as the spray deployment equipment 212 and erecting tower 214, may be able to maintain a minimum of clearance around the opening 222, such as about 1 inch, 2 inches, 5 inches, or other suitable distance. The fluid application device 210 may fit within an area, such as a ground ring 250, underneath the object 220, as illustrated. For example, the fluid application device 210 may fit within a diameter about the center of about 48 inches, 72 inches, 96 inches, or other suitable distances.

As illustrated, in an undeployed state or an initially deployed state, the height 240 reached by the tower 214 may be about below or a small distance inside the opening 222. For example, the tower 214 in an undeployed state or stowed to facilitate movement underneath the object 220 may be shorter than about 72 inches, 111 inches, 124 inches, or another suitable distance. At the height 240 in an undeployed state or an initially deployed state, fluid spray from the spray deployment equipment 212 may not reach or be able to be applied to the surface 224. In an undeployed state, the spray deployment equipment 212 may be below the opening 222 or a small distance inside the opening 222, such as is the object is lowered over the fluid application device 210 or the spray deployment equipment 212 are placed on top of the tower 214. One or more components of the fluid application device 210 may comprise non-corrosive material or fluid-resistant material, such as stainless steel, chrome plating, rubber, or other material. The fluid application device 210 may be portable or movable on the ground, and may include movement devices such as lifting hooks, wheels, casters, and integrated powered transportation systems.

As illustrated, the object 220 may be at least partially supported by a ground ring 250 and/or a support adapter 260. The ground ring 250 and/or the support adapter 260 may allow the fluid application device 210 to be positioned near or below the opening 222. The support adapter 260 may adapt to support different objects, or may be interchangeable with other support adapters which support other objects. In another example, the object may be positioned on or close to the ground-level 230 on which the fluid application device 210 is positioned or supported. The fluid applied to the surface 224 may be able to drain through the opening 222 and over the fluid application device 210. The fluid application device 210 may also include a fluid collection device 216 or containment berm able to receive fluid that drains from the surface 224, such as through the opening 222. The fluid collection device 216 may be positioned at least partially on or under the fluid application device 210, and may surround the tower 214. One or more pumps may remove the drained fluid from the fluid collection device 216, such as to a remote drain, a sanitary sewer, or a holding tank. The ground-level 230 or a surface at the ground-level 230 may at least partially support the fluid application device 210. The ground-level 230 or a surface at the ground-level 230 may include one or more anchors 232 or attachment points to secure the fluid application device 210, the object 220, or other relevant systems. The fluid application device 210 may be secured in place during deployment of the tower 214 or during the spraying process, such as to provide stability. The fluid application device 210 may be secured in place using the anchors 232, deployable outriggers, or other suitable devices.

FIG. 2B illustrates a cut-out view of the example fluid spraying assembly 200 in a partially deployed state, in accordance with at least one embodiment. It should be understood that reference numbers may be carried over between figures for similar components for ease of explanation and understanding, but such usage should not be interpreted as a limitation on the scope of the various embodiments unless otherwise specifically stated. The fluid spraying assembly 200 may be transitioned to the partially deployed state, such as from the undeployed state as described regarding FIG. 2A or from the fully deployed state as described regarding FIG. 2C. As illustrated, in the partially deployed state the height 240 reached by the tower 214 may be above the opening 222 of the surface 224 and below a maximum distance reachable by the tower 214, such as below underneath the height of the tower 214 in the fully deployed state. In the partially deployed state, fluid spray from the spray deployment equipment 212 may reach or be applied to only a lower portion of the surface 224. FIG. 2C illustrates a cut-out view of the example fluid spraying assembly 200 in a fully deployed state, in accordance with at least one embodiment. As illustrated, in a fully deployed state the height 240 reached by the tower 214 may be above the opening 222 and at a maximum distance reachable by the tower 214. At this height 240 fluid spray from the spray deployment equipment 212 may reach or be applied to at least the top of the surface 224 or all of the surface 224.

In an example, the fluid application device 210 may be able to apply a fluid to the object with the opening 222 about 100 inches or about 160 inches above the ground-level 230, a maximum height of the surface 224 at about 744 inches or about 960 inches, and a radius of the surface 224 of about 144 inches or about 196 inches. The fluid spraying assembly 200 may have a ratio of the maximum deployed distance of the tower 214 to the maximum width of the fluid application device 210 of at least about 7:1, about 4:1, about 10:1, or other suitable ratios. The fluid spraying assembly 200 may have a ratio of maximum height to maximum width of the tower 214 of at least about 20:1, about 6:1, about 50:1, or other suitable ratios. The extended height to retracted height ratio of the fluid spraying assembly 200 may be at least about 10:1, about 7.5:1, about 15:1, or other suitable ratios, wherein the fluid spraying assembly 200 and/or the tower 214 is self-supporting. The footprint of the fluid application device 210 may be about 1,000 square inches, about 1,500 square inches, about 2,000 square inches, or other suitable size.

The fluid spraying assembly 200 may be used to spray one or more fluids on the surface 224, such as one or more interior surfaces of a propellant tank of a rocket or launch vehicle. In one example, the surface 224 may be an interior surface of a LOX, LH2, or a combination LOX and LH2 propellant tank, such as for a New Glenn® GTO or LEO launch vehicle by Blue Origin®, the New Shepard® suborbital launch or space vehicle by Blue Origin®, or other suitable system. The propellant tank or other object with surface 224 may be positioned at a location on the ground ring 250, or the support adapter 260. The fluid application device 210 may be moved to the location of the propellant tank and supported at the ground-level 230. The fluid application device 210 may be positioned at least partially under the opening 222, where at least a portion of the tower 214 can be vertically extended into the tank. The fluid application device 210 may be used to extend the tower 214 through the opening 222 and raise the spray deployment equipment 212 substantially vertically along the height 240.

The tower 214 may be moved up and down, such as incrementally between a maximum height and a minimum height required for the tank, according to one or more processes to apply the fluids to the surface 224. In an example, to clean a LOX propellant tank, the spray deployment equipment 212 may be positioned near a top of the surface 224 and may use a nozzle angled about 45-degrees up, or about 90-degrees up, to spray an upper portion or upper dome of the tank. Then, the spray deployment equipment 212 may be positioned near a center of the surface 224 and may use a nozzle angled about 0-degrees at horizontal to spray a middle portion or middle barrel of the tank. Next, the spray deployment equipment 212 may be positioned near a bottom of the surface 224 and may use a nozzle angled about 45-degrees down, or about 90-degrees down, to spray a lower portion or lower dome of the tank. Finally, the fluid application device 210 may be used to retract the tower 214 through the opening 222 and lower the spray deployment equipment 212 substantially vertically along the height 240. The process may be substantially reversed, with spraying beginning near the bottom of the surface 224 and with spraying completing near the top of the surface 224. The tower 214 may be erected, such as incrementally, to raise or lower the fluid application device 210 while spraying, which may allow for additional areas of the surface 224 to be sprayed. One or more nozzles may be used and angled at one or more angles during the process.

FIG. 2D illustrates a cut-out view of the example fluid spraying assembly 200 able to tilt in a partially deployed state or a fully deployed state, in accordance with at least one embodiment. The fluid application device 210 of the fluid spraying assembly 200 may have one or more components, such as actuators, able to allow the tower 214 to tilt away from a substantially vertical position at an angle 270. The tilt of the tower 214 may allow the spray deployment equipment 212 to be positioned closer to the surface 224, which may allow for more precise control of the spray or may apply a more powerful spray to the surface. The tower 214 may be titled in one or more directions, and the angle 270 may be any suitable angle, such as up to about 5-degrees, 10-degrees, 20-degrees, or other suitable amounts. In an example, the tower 214 may be tilted at an angle 270 from vertical with the top of the tower 214 at a height from the ground up to at least about 510 inches, 602 inches, or another height suitable to spray a LOX or a LH2 tank. The tower 214 may include one or more components, such as a universal joint or other suitable connection at the tower 214 base, able to rotate the tower 214 about a vertical axis, such as the axis of the tower 214 when vertical or the axis of the fluid application device 210. The tower 214 may be able to rotate when tilted at the angle 270, by way of the tilting actuators and the universal joint or other suitable connection. In an example, the tower 214 may be able to move in a circumscribed pattern around the interior of the object 220. The fluid spraying assembly 200 may include other features able to control, operate, move, or position the spray deployment equipment 212. For example, an additional vertical and/or horizontal extension may be able to place a spray origination point of the spray deployment equipment 212 closer to a surface 224, which can increase spray efficacy. In another example, fluid spraying assembly 200 may include a controllable arm, directional nozzle, horizontally extending nozzle, articulating arm, or other system.

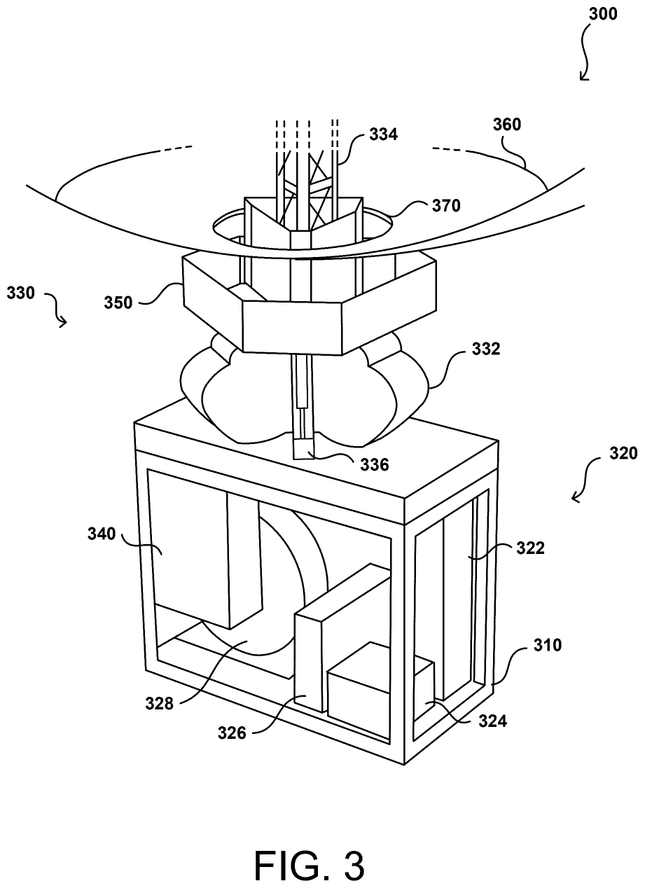

FIG. 3 illustrates another example fluid spraying assembly 300, in accordance with at least one embodiment. The fluid spraying assembly 300 may include a frame 310, a fluid system 320, a tower device 330, a control unit 340, and an integrated catchment 350. The frame 310 of the fluid spraying assembly 300 may at least partially house or support one or more components of the fluid system 320, the tower device 330, the control unit 340, and the integrated catchment 350. As illustrated, the frame 310 may house the fluid system 320 and the control unit 340 and may support the tower device 330 and the integrated catchment 350. One or more of the components of the fluid spraying assembly 300 may be smaller or more compact than the fluid spraying assembly 100 as illustrated in FIG. 1. The components of the fluid spraying assembly 300 may be fluidly connectable, such as the fluid system 320 and the tower device 330, which may include one or more fluid sources and one or more spray devices or nozzles.

The fluid system 320 of the fluid spraying assembly 300 may include a fluid pump 322, a dosing pump 324, a filter manifold 326, and a hose reel 328. The fluid pump 322, such as a Grundfos CRNE 15-8, may increase the pressure from a fluid source in order to provide the required nozzle outlet pressure. In an example, the fluid pump 322 may increase the pressure to about 120 PSI, 150 PSI, 180 PSI, or another suitable pressure. The dosing pump 324 may deliver one or more additional fluids into a primary supply stream. In an example, the dosing pump may provide a required amount of cleaning solution, or other solution, to achieve a mixture of about 1% ±0.5% to about 60% ±5%. The dosing pump 324 may receive the additional fluid from a secondary fluid source or a secondary reservoir. The fluid system 320 may also include actuators, valves, and controls to switch between cycles, such as a rinse cycle having a primary fluid only and wash cycles having a primary fluid and an additional fluid, such as a cleaning solution. The switching of cycles may be performed automatically within sequencing of an automated computer program. The filter manifold 326 may be used to filter the primary and/or secondary fluid provided from the fluid pump 322 and the dosing pump 324 to the hose reel 328. The filter manifold 326 may have a filter, such as a 5-micron filter, 10-micron filter, 15-micron filter, or another suitable filter. The hose reel 328 may manage one or more hoses, as at least one hose is moved along with a tower unit 334. The hose reel 328 may be motor-controlled, semi-automated, or fully automated, manually controlled, or synchronized with the movement of the tower unit 334. The hose reel 328 may be able to operate as a free wheel, such as when the tower unit 334 is raised to allow the required hose to be provided. The hose reel 328 may be automated, such as electronically connected with the tower unit 334 to provide and retrieve hose as the tower unit 334 is erected or dismantled. One or more hoses may travel with the tower unit 334 and may be guided with the use of rollers, sheaves, guides, or other suitable devices, such as to prevent binding, chafing, or pinching on surrounding components, an opening 370, or a surface 360.

The tower device 330 of the fluid spraying assembly 300 may include a management unit 332, the tower unit 334, and an actuation unit 336. The management unit 332 may be able to store combinable components of the tower unit 334 when retracted or partially retracted, may be able to assemble the combinable components of the tower unit 334 when being deployed or being partially deployed, and may be able to disassemble combinable components of the tower unit 334 when being retracted or being partially retracted. The management unit 332 may include bales able to receive the combinable components for storage. The bales of the management unit 332 may be able to provide the combinable components for assembly. The combinable components, such as rigid interlocking sections, may be assembled to form the tower unit 334 as a self-supporting structure. To assemble the self-supporting structure of the tower unit 334, a drive motor and a guide system may be used to translate and align the combinable components in order to interlock. The tower unit 334 may be raised and lowered at least substantially vertically, such as through the opening 370, using the management unit 332. The tower unit 334 may be assembled and deployed, or disassembled and stowed, using the management unit 332 to raise and lower the equipment mounted to the tower unit 334, such as spraying equipment, nozzles, hoses, sensors, cables, and other suitable devices. After initial setup and preparations of the fluid spraying assembly 300, the tower unit 334 may be assembled and deployed or disassembled and stowed in a limited amount of time, such as less than 10 minutes, 5 minutes, 2 minutes, or less than 1 minute. The actuation unit 336 may include one or more parts, such as actuators, turntables, balancers, or universal joints, able to at least tilt, rotate, or circumscribe the tower unit 334 in a circular pattern. The control unit 340 may include one or more components, such as interfaces, timers, switches, communications systems circuits, or other components, able to be used to control one or more systems, parts, or subparts of the fluid spraying assembly 300.

The integrated catchment 350, or effluent control basin, of the fluid spraying assembly 300 may be used to control disposal of at least a portion of the processed fluid and rinse fluid drained from the opening 370 of the surface 360. In an embodiment, the integrated catchment 350 may receive at least a portion of the fluid before it contacts the rest of the fluid spraying assembly 300. Processed fluid and rinse fluid may be captured in the integrated catchment 350 after exiting the surface 360 and routed to a sanitary sewer, stormwater waste streams, storage containers, or other suitable locations. The integrated catchment 350 may be a catch basin attached to the fluid spraying assembly 300 or the tower device 330, a containment berm located at ground level, or other assemblies. One or more catchment pumps associated with, such as located within, below, or adjacent to, the integrated catchment 350 may transfer the fluid to a remote location or container for disposal, storage, or testing, and the catchment pumps may be capable of operating at a flow rate greater than the flow rate of the fluid system 320, such as at a flow rate of about 80 gallons per minute. The catchment pumps may be able to operate in synchronization with the fluid system 320 or the fluid pump 322, such as powering on or off automatically to clear processed fluid from the integrated catchment 350. The integrated catchment 350 may include a drained fluid level monitoring device to control the operation of the catchment pumps. The integrated catchment 350 may be able to minimize splashing, misting, or wetting surfaces around the fluid spraying assembly 300, such as using one or more moveable membrane barriers, having a specific size and shape, or other methods. Disposal of fluids used by the fluid spraying assembly 300 may be regulated, such as by the Environmental Protection Agency (EPA), which may require control of the fluid as it drains from the surface 360. The integrated catchment 350, associated pumps, and other components of the fluid spraying assembly 300, may be used to manage disposal of the fluids. For example, disposal pumps may be operated to remove the fluid from the integrated catchment 350 or other areas, such as when triggered by a level detection float or other sensor. The drained fluid may also be collected and inspected, such as to be compared with a sample from the surface 360. The drained fluid inspection, which may or may not involve other sampling methods, may assess the cleanliness of the surface 360 and/or the effectiveness of the fluid spraying assembly 300.

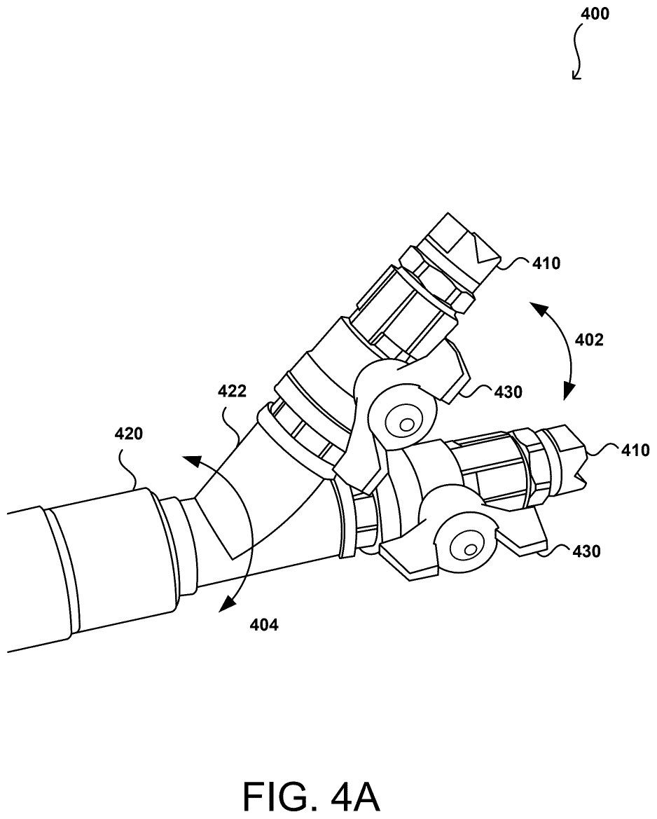

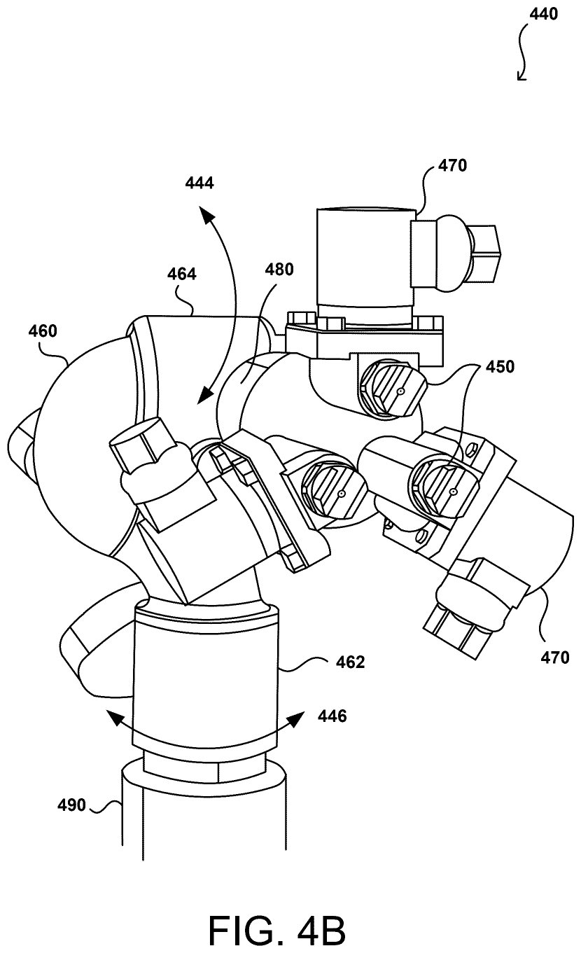

FIG. 4A illustrates an example spraying device 400 for a fluid spraying assembly, in accordance with at least one embodiment. The spraying device 400 may be part of a fluid spraying assembly, such as the spraying device 120 of the fluid spraying assembly 100, as described regarding FIG. 1, or the spray deployment equipment 212 of the fluid spraying assembly 200, as described regarding FIGS. 2A-2D. The spraying device 400 may include one or more nozzles 410, a fluid source 420, an adapter 422, and one or more valves 430. The nozzles 410 may be fluidly connectable with the fluid source 420, such as using an adapter 422. The spraying device 400 may be able to receive a fluid from the fluid source 420 and spray the fluid, such as onto a surface. The fluid source 420 may be secured to a mount to at least partially support the spraying device 400. The fluid may spray from the nozzles 410 at about 100 pounds per square inch (PSI) and at about 40 gallons per minute (GPM), per nozzle, or other suitable rates. For example, one or more of the nozzles 410 may be able to spray in about a 15-degree fan, or other suitable fans. The nozzles 410 may be interchangeable and different nozzles may be used for different applications, processes, or fluids.

The spraying device 400 may be able to rotate around an axis of interior surface or object, or around an axis of a mount, such as on a tower or a fluid spraying assembly. For example, the spraying device 400 may be able to rotate 360-degrees continuously around the axis. The rotation of the spraying device 400 may be automatic or autonomous, and may be rotated by the flow of the fluid from the fluid source 420 or may be powered by one or more other systems. The rotation of the spraying device 400 may provide a linear speed of the spray impacting a surface of up to about 25 feet per minute, 50 feet per minute, 75 feet per minute, or other suitable rates. The rotation of the spraying device 400 may be caused using a rotary spray tank cleaning device, such as an Alfa Laval spray head, which may be performed at least semi-autonomously based on the delivered flow of fluid. The rotation of the spraying device 400 may be performed according to a preprogrammed sequence, such as depending on use with different surfaces, objects, or processes.

The valves 430 may be fluidly connectable with the nozzles 410 to control the flow of fluid from the fluid source 420. For example, the valves 430 may be connected to corresponding ones of the nozzles 410 and may be adjusted manually or automatically. Depending on the conditions and processes to be performed, one or more of the valves 430 may be opened, closed, partially opened, or adjusted. The valves 430 may be operated before, during, or after one or more processes. One or more of the nozzles 410, along with a corresponding one of the valves 430, may be positioned away from another valve or away from a plane at an angle 402, such as to spray the fluid toward a specified direction or area. The angle 402 may be at about 30-degrees, 45-degrees, 90-degrees, or any other suitable angle, and may be adjusted manually or automatically, such as before, during, or after one or more processes. As illustrated, at least a portion of the spraying device 400 may be rotated 404 to position one or more of the valves 430 at an alternative location. For example, the adapter 422, nozzles 410, and valves 430 may be rotated 180-degrees so an upper valve is positioned below a middle valve as a lower valve, which can cause the spray direction of the upper valve to be changed from a partially upward direction to a partially downward direction. The rotation 404 may be performed manually or automatically, such as before, during, or after one or more processes.

FIG. 4B illustrates an alternative example spraying device 440 for a fluid spraying assembly, in accordance with at least one embodiment. The spraying device 440 may share one or more features with spraying device 400, as described regarding FIG. 4A The spraying device 440 may include a fluid source 490, one or more nozzles 450, a fluid cannon 460, one or more valves 470, an axial rotation mechanism 462, an orthogonal rotation mechanism 464, and a manifold 480. The nozzles 450 may be fluidly connectable with the fluid source 490, such as using the fluid cannon 460 or manifold 480. The fluid source 490 may be secured to a mount to at least partially support the spraying device 440. The spraying device 440 may be able to receive a fluid from the fluid source 490 and spray the fluid, such as onto a surface.

The fluid cannon 460 may be able to control, move, and position at least one or more components of the spraying device 440, such as to provide broad spray coverage suitable for different surfaces or processes. For example, the fluid cannon 460 may facilitate the direction of the spray discharged from the nozzles 410. The control of the spraying device 440 by the fluid cannon 460 may be performed manually or automatically, such as before, during, or after one or more processes. The fluid cannon 460 may be a robotic fire monitor, such as an Elkhart Brass BrushHawk or another suitable device. The fluid cannon 460 may control the spray path or other actions of the spraying device 440, and may be programmable or automated, such as within the sequencing of a spraying program. For example, the fluid cannon 460 may be able to angle the nozzles along one or more directions, target specific locations, control the discharge rate, or other suitable actions. In another embodiment, the fluid cannon 460 may control the fluid spray to complete the steps for cleaning interior surfaces of a tank.

The fluid cannon 460 may be able to position the nozzles 450, along with the corresponding valves 470, another valve or away from a plane, such as to spray the fluid toward a specified direction or area. The angle 402 may be 30-degrees, 45-degrees, 90-degrees, or any other suitable angle, and may be adjusted manually or automatically, such as before, during, or after one or more processes. The axial rotation mechanism 462 may be used to enable axial rotation 446 of the spraying device 440, such as around an axis along the direction of extension of the tower and/or along the length of the interior surface or object. In an example, the axial rotation mechanism 462 may rotate around an axis of a mount positioned on a tower or a fluid spraying assembly. The axial rotation 446 of the spraying device 440 may be performed according to a preprogrammed sequence, such as depending on use with different surfaces, objects, or processes. The axial rotation mechanism 462 may be able to rotate the spraying device 440 continuously 360-degrees in one or more directions and/or position the spraying device 440 on a substantially horizontal plane. The orthogonal rotation mechanism 464 may be used to enable orthogonal rotation 444 of the spraying device 440, such as around an axis which is perpendicular to the axial rotation 446 enabled by the axial rotation mechanism 462. In an example, the orthogonal rotation mechanism 464 may rotate around an axis orthogonal to an axis of a mount positioned on a tower or a fluid spraying assembly. The orthogonal rotation 444 of the spraying device 440 may be performed according to a preprogrammed sequence, such as depending on use with different surfaces, objects, or processes. The orthogonal rotation mechanism 464 may be able to rotate the spraying device 440 continuously 360-degrees in one or more directions and/or position the spraying device 440 on a substantially vertical plane, such as in a version not illustrated. The spraying device 440 may include additional rotation mechanism or positioning mechanisms, such as to enable diagonal rotation or non-rotational motions.

The valves 470 may be fluidly connectable with the nozzles 450 to control the flow of fluid from the fluid source 490. The valves 470 may include solenoids and may be controlled by the fluid cannon 460. For example, the fluid cannon 460 may be able to provide fluid flow to individual ones of the valves 470 and may be able to control actuation of the valves 470, which can allow for switching between the nozzles 450. For example, fluid cannon 460 may switch between the nozzles 450 based on the nozzle type or the nozzle direction. The fluid cannon 460 or the manifold may include fluid paths to the valves 470 or may be able to switch between channels of the valves 470. For example, individual valves 470 may be actuated to allow fluid flow to corresponding nozzles 450 having different nozzle types, such as between a broad-coverage fan-spray nozzle used to apply cleaning solution, a jet style nozzle used to reach far distant or areas with suspected high-concentration of particulate reside, and other suitable nozzles.

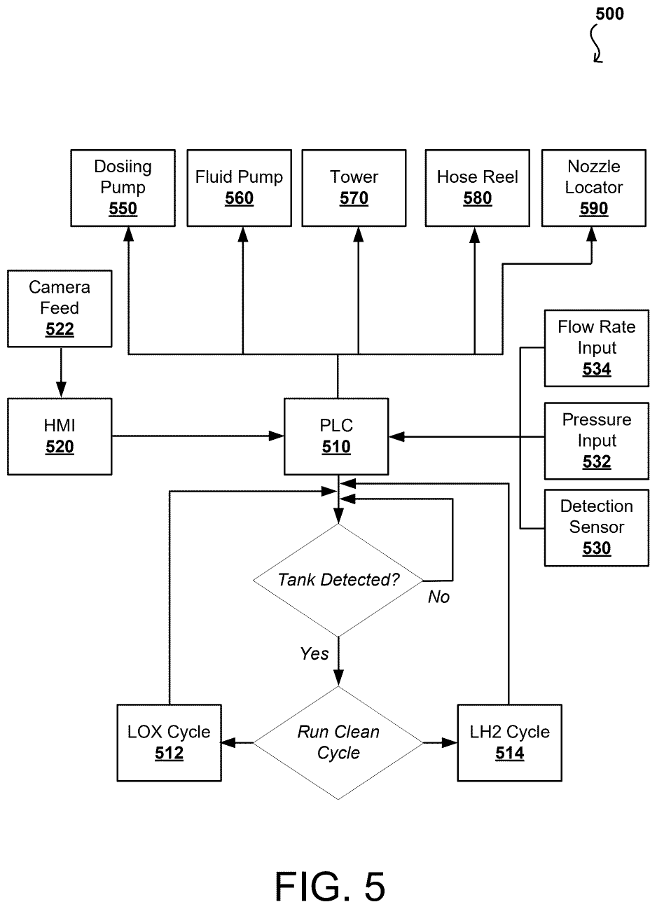

FIG. 5 illustrates an example control system 500 for a fluid spraying assembly, in accordance with at least one embodiment. The control system 500 may be used with a fluid spraying assembly, such as the fluid spraying assembly 100, as described regarding FIG. 1 or the fluid spraying assembly 200, as described regarding FIGS. 2A-2D. The control system 500 may include program control logic (PLC) 510, which may be used to operate one or more features of a fluid spraying assembly, and may be connected to one or more local or remote computing systems. The control system 500 may also include or cooperate with one or more of controls hardware, logic states, peripheral hardware, subsystem components, sub-routine containers, and processes. The PLC 510, or other components of the control system 500, may be operated by a user with a human-machine interface (HMI) 520. The HMI 520 may include one or more devices having available inputs, outputs, screens, readouts, or other suitable features. The HMI 520 may also be other devices, such as emergency stops or emergency push buttons. The HMI 520 or PLC 510 may receive one or more camera feeds 522 or other sensor data feeds, which may be displayed on a screen to a user. The feeds may also be provided to over components of the control system 500 and may be stored or analyzed.

Inputs to the HMI 520 may indicate instructions to run or start one or more programs for the fluid spraying assembly, which may be provided to the PLC. The programs may include specific programs that can be run based on the different fluids, surfaces, processes, or other variables, such as a LOX cycle program 512 for cleaning a LOX tank or a LH2 cycle program 514 for cleaning a LOX tank. A user may be able to monitor the fluid spraying assembly or a running program from the HMI 520, such as from the screen or other output. One or more detection sensors 530 may be used to trigger the PLC 510 to run a program for the fluid spraying assembly. For example, the detection sensors 530 may identify the presence of a specific object or surface for which a fluid can be applied. In this example, the detection sensors 530 may identify the presence of a LOX tank interior surface or a LH2 tank, which can trigger running of the LOX cycle program 512 or the LH2 cycle program 514. The HMI 520 may prompt a user to provide confirmation of the correct tank configuration prior to running the program. The detection sensors 530 may rely on one or more features to identify the program to be triggers, such as size, shape, color, presence or absence of objects, distance from a tower height to a next surface above the tower, or other features. For example, the PLC 510 may use information from at least the detection sensors 530 to determine whether a tank is detected. If a tank is detected, the PLC 510 may determine from the information which type of tank is detected. Depending on the type of tank detected, the PLC 510 may send instructions, or send a prompt to confirm instructions, to run a clean cycle, such as the LOX cycle program 512 or the LH2 cycle program 514. If a tank is not detected, the PLC 510 may wait for an input, such as from the detection sensors 530, which indicates that a tank is detected.

The PLC 510 may also be able to control the operation of components of the fluid spraying assembly, including a dosing pump 550, a fluid pump 560, a tower 570, a hose reel 580, and a nozzle locator 590. For example, the PLC 510 may be able to simultaneously operate the components of the fluid spraying assembly to perform functions including at least: circumscribe movement of the tower 570, movement of the nozzle using the nozzle locator 590 including rotation and tilt, operation of the fluid pump 560, operation of the dosing pump 550, and operation of one or more disposal pumps, 2) vertical movement of the tower 570 and operation of the hose reel 580, and 3) movement of the nozzle using the nozzle locator 590 including rotation and tilt, operation of the fluid pump 560, operation of the dosing pump 550, and operation of one or more disposal pumps. The HMI 520 may provide real-time information about functions performed according to the PLC 510 to a user. The PLC 510 may receive information about one or more of these components, such as from the detection sensors 530 or other devices. The HMI 520 may provide user information about one or more of these components, such as in real-time. The information received by the PLC and provided by the HMI to a user may include the tower 570 height, step descriptions of cycles or programs, time remaining until running program completion, percentage of running cycles or programs completed, the camera feed 522, or other relevant data. The information may also include a pressure input 532 for the pressure at the nozzle or near the nozzle outlet and a flow rate input 534 for the flow rate at the nozzle or near the nozzle outlet.

The control system 500 may be used to perform one or more processes to apply fluids to objects or surfaces, such as a vertically oriented storage tank. In an example, a vertical cleaning robot (VCR), or a fluid spraying assembly, may be operated by the control system 500 using a cleaning process to clean a vertically orientation storage tank, having a LOX portion and a LH2 portion. In this example, the VCR may be positioned underneath the storage tank, such as inside a ground ring, with the LOX portion closest to the VCR. The VCR may be connected to electrical power, water, and a cleaning solution supply. The cleaning process may use de-ionized (DI) water for pre-wash and rinse cycles, and DI water combined with about 1% or about 50% cleaning solution, such as a mild alkaline cleaner, for the wash cycle. The VCR and a collection berm may be connected to a disposal line. The facility DI water pumps may be turned on to provide the DI water to the VCR. The VCR may be powered on and the HMI 520 may receive an input indicating instructions to start the LOX cycle program 512 to commence a cleaning process.

The LOX cycle program 512 may first include a pre-wash portion. The pre-wash portion may include the following steps: extend the tower 570 to a maximum height while paying out from the hose reel 580, turn on the fluid pump 560 to allow the nozzle locator 590 to spray DI water in a 360-degree sweep, move the tower 570 down while reeling into the hose reel 580, turn off the fluid pump 560, and repeat the previous two steps until the tower 570 is back to a minimum height. The LOX cycle program 512 may second include a wash portion. The wash portion may include the following steps: extend the tower 570 to a maximum height while paying out from the hose reel 580, turn on the fluid pump 560 and dosing pump 550 to allow the nozzle locator 590 to spray DI water and cleaning solution in a 360-degree sweep, move the tower 570 down while reeling into the hose reel 580, turn off the fluid pump 560, and repeat the previous two steps until the tower 570 is back to a minimum height. The LOX cycle program 512 may third include a rinse portion. The rinse portion may include the following steps: extend the tower 570 to a maximum height while paying out from the hose reel 580, turn on the fluid pump 560 to allow the nozzle locator 590 to spray DI water in a 360-degree sweep, move the tower 570 down while reeling into the hose reel 580, turn off the fluid pump 560, and repeat the previous two steps until the tower 570 is back to a minimum height. The rinse portion of the LOX cycle program 512 may automatically be performed twice.

Once the LOX cycle program 512 cleaning process is complete, the VCR may be moved to allow sufficient space for providing drying equipment to begin drying the tank. The tank may be removed from the ground ring and then inverted to have the LH2 portion of the tank closest to the location provided for the VCR. The VCR may be provided back underneath the storage tank. To start the LH2 cycle program 514, the HMI 520 may receive an input indicating instructions to start the LH2 cycle program 514 to commence a cleaning process. The LH2 cycle program 514 may include one or more steps of the LOX cycle program 512 as well as additional steps. Once the LH2 cycle program 514 cleaning process is complete, the VCR may be moved to allow drying equipment to be connected to the tank to begin drying. To eliminate the necessity of moving the VCR to begin drying the tank, drying equipment may be at least partially incorporated into the VCR. During the steps, the nozzle locator 590 may need to rotate up and/or down in some positions, such as to spray domes and behind hardware. The precision of the spray pattern may be less critical during some steps, cycles, or programs. One or more of the steps, cycles, or programs performed using the control system 500 may be performed more than once.

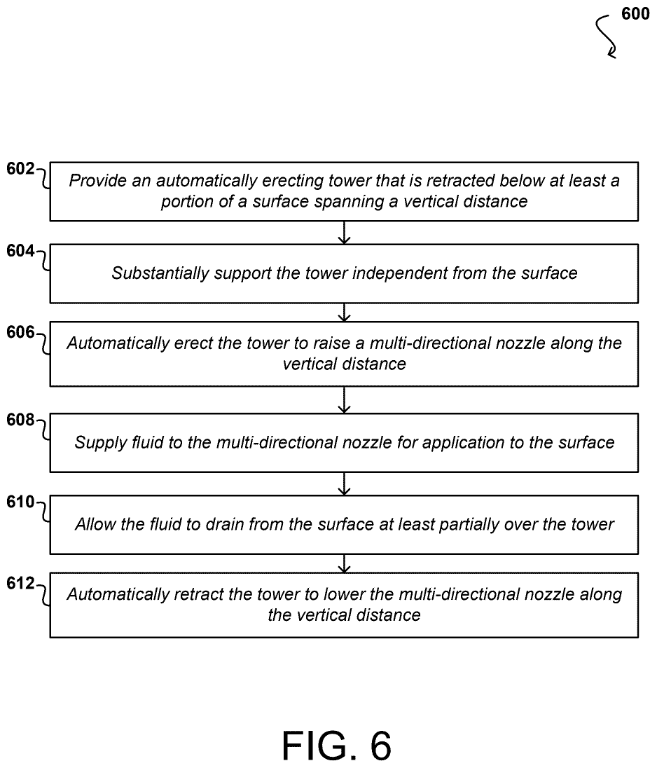

FIG. 6 illustrates an example process 600 that can be performed to apply fluid to a surface, in accordance with at least one embodiment. It should be understood that for this and other processes presented herein that there may be additional, fewer, or alternative operations performed in similar or alternative orders, or at least partially in parallel, within the scope of the various embodiments unless otherwise specifically stated. In this example, an automatically erecting tower is provided 602 that is retracted below at least a portion of a surface spanning a vertical distance. The tower can raise and lower a spraying device, such as a multi-directional nozzle. The spraying device or the nozzle can rotate about an axis, can be controllable while operating, or can be operated according to an automated programmed process. The tower can have a stored form, an extended form, and a partially extended form. The surface can be an internal surface of a propellant tank with a polar opening able to receive the tower. The tower is substantially supported 604 independent from the surface. The tower can be a ground-based machine, supported externally and separately from the surface. The tower is automatically erected 606 to raise the multi-directional nozzle along the vertical distance. At least a portion of the tower and the multi-directional nozzle can be sized to vertically pass through an opening near the bottom of the surface. The tower and/or the multi-directional nozzle can be tilted, rotated, circumscribed, or articulated. The tower can be formed and raised by combining rigid interlocking components. A ratio of a maximum deployed distance of the tower to the maximum width of a base for the tower can be at least 5:1. A ratio of a maximum height to a maximum width of the tower can be at least 20:1.

Fluid is supplied 608 to the multi-directional nozzle for application to the surface. One or more fluid pumps, dosing pumps, hoses, hose reels, control systems, connectors, and power systems can be used to provide the fluid. The fluid can be provided from one or more reservoirs. The fluid can be provided from a source positioned on or near the ground-level up to about a maximum height of the tower. The fluid can be applied from the multi-directional nozzle in order to clean the surface. The fluid is allowed 610 to drain from the surface at least partially over the tower. The drained fluid can be collected before reaching the ground or body supporting the tower. A sample of the drained fluid can be collected, such as for analysis or comparison. The tower can include an integrated catchment or basin to collect at least a portion of the drained fluid. The tower is automatically retracted 612 to lower the multi-directional nozzle along the vertical distance. The tower can be lowered and stowed by separating the rigid interlocking components. The surface and/or the tower can be removed from the location, such as after completing a process including the application of the fluid. One or more operations of the tower, the multi-directional nozzle, or the fluid supply can be programmed or automatically initiated and/or completed.

Other variations are within the spirit of the present description. Thus, while the described techniques are susceptible to various modifications and alternative constructions, certain illustrated embodiments thereof are shown in drawings and have been described above in detail. It should be understood, however, that there is no intention to limit description to specific form or forms described, but on contrary, intention is to cover all modifications, alternative constructions, and equivalents falling within spirit and scope of description, as defined in appended claims.

Terms such as “comprising,” “having,” “including,” and “containing” are to be construed as open-ended terms (meaning “including, but not limited to”,) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Use of any and all examples, or exemplary language (e.g., “such as”) provided herein, is intended merely to better illuminate embodiments of the description and does not pose a limitation on scope of description unless otherwise claimed. No language in specification should be construed as indicating any non-claimed element as essential to practice of the description.

Although descriptions herein set forth example implementations of described techniques, other architectures may be used to implement described functionality, and are intended to be within scope of this description. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are described as exemplary forms of implementing the claims.

What is claimed is:

1. An assembly for fluid application in a tank interior, the assembly comprising:
a base having deployable components configured to be positioned at least partially below an opening into the tank interior, the deployable components further configured to deploy an adjustable length self-supporting mast;
a rotatable spraying device configured to be raised by the mast through the opening and into the tank interior; and
a fluid delivery system configured to provide fluid to be sprayed within the tank interior.

2. The assembly for spraying in a storage tank interior of claim 1, further comprising:
an electronic control system to at least partially operate at least a portion of the assembly.

3. The assembly for spraying in a storage tank interior of claim 1, further comprising:
a fluid catchment to receive fluid draining from the tank interior.

4. The assembly for spraying in a storage tank interior of claim 2, wherein the base is configured to be portable.

5. The assembly for spraying in a storage tank interior of claim 1, wherein the rotatable spraying device rotates substantially around one or more of a vertical axis or an axis along at least a portion of the mast.

6. The assembly for spraying in a storage tank interior of claim 1, wherein a ratio of a maximum deployed distance of the mast to a maximum width of the base is at least 5:1.

7. The assembly for spraying in a storage tank interior of claim 1, wherein the mast is configured to be vertically retracted into the deployable components.

8. A fluid application device, comprising:
one or more nozzles to apply a flow of fluid in a plurality of selectable directions;
at least one component to provide the flow of fluid to the one or more nozzles; and
an automatically erecting tower to receive the one or more nozzles, wherein the one or more nozzles are positioned along a height as the tower is erected.

9. The fluid application device of claim 8, wherein the application of flow of fluid by the one or more nozzles is automated or semi-automated.

10. The fluid application device of claim 8, further comprising:
an extendable member to position at least one of the nozzles relative to the tower.

11. The fluid application device of claim 8, wherein at least one component fluidly connects a fluid source with the one or more nozzles along the height.

12. The fluid application device of claim 11, wherein the at least one component includes a pump and a hose.

13. The fluid application device of claim 8, wherein a ratio of maximum height to maximum width of the tower is at least 20:1.

14. The fluid application device of claim 8, wherein the tower is able to tilt along the height.

15. The fluid application device of claim 8, wherein a fluid cannon at least partially controls the one or more nozzles or the flow of fluid to the one or more nozzles.

16. A method, comprising:
providing an automatically erecting tower retracted below at least a portion of a surface spanning a vertical distance, the tower having a multi-directional spraying device;
automatically erecting the tower to raise the multi-directional spraying device along the vertical distance; and
supplying fluid to the multi-directional spraying device for application to the surface.

17. The method of claim 16, further comprising:
substantially supporting the tower independent from the surface.

18. The method of claim 16, further comprising:
allowing the fluid to drain from the surface at least partially over the tower.

19. The method of claim 16, wherein an outer dimension of the tower is sized to pass through an opening as the tower is erected to provide the multi-directional spraying device access to the surface.

20. The method of claim 16, further comprising:
automatically retracting the tower to lower the multi-directional spraying device along the vertical distance.
